(19) United States
(12) Patent Application Publication
(10) Pub. No.: US 2019/0005815 A1
(43) Pub. Date: Jan. 3, 2019

(54) TRAFFIC LIGHT

(71) Applicant: Lite-On Technology Corporation, Taipei (TW)

(72) Inventors: Ching-Tsung Ni, Taipei (TW); Wei-Bin Hsu, Taipei (TW)

(73) Assignee: Lite-On Technology Corporation, Taipei (TW)

(21) Appl. No.: 15/978,212

(22) Filed: May 14, 2018

Related U.S. Application Data
(60) Provisional application No. 62/528,155, filed on Jul. 3, 2017.

(30) Foreign Application Priority Data
Mar. 5, 2018 (CN) 201810178716.9

(51) Int. Cl. G08G 1/095; F21V 8/00

(52) U.S. Cl. CPC G08G 1/095; G02B 6/0073; G02B 6/0031; G02B 6/0026; G02B 6/0028; G02B 6/0025

(57) ABSTRACT

A traffic light including a plurality of light emitting elements and at least one light guide plate is provided. Each of the light emitting elements is configured to emit a light. The light emitting elements are disposed beside a light entering surface of the at least one light guide plate. Each of the lights enters the at least one light guide plate through the light entering surface of the at least one light guide plate.

### CROSS-REFERENCE TO RELATED APPLICATION

This application claims the priority benefit of U.S. provisional application Ser. No. 62/528,155, filed on Jul. 3, 2017, and China application serial no. 201810178716.9, filed on Mar. 5, 2018. The entirety of each of the above-mentioned patent applications is hereby incorporated by reference herein and made a part of this specification.

### BACKGROUND OF THE INVENTION

### Field of the Invention

The invention relates to a traffic light, and particularly relates to a traffic light having a light guide plate.

### Description of Related Art

Traffic lights provide guidance signals for guiding vehicles and pedestrians on the road to march, stop or make a turn in order to maintain traffic discipline, which are important facility for traffic safety.

In one type of the existing traffic light, a plurality of light emitting diodes (LEDs) configured in a matrix are adopted to emit lights. However, since lighting performance of each of the LEDs is similar to a light spot, even if these LEDs are arranged in a dense manner, in view of a lighting effect of the traffic light, point light sources are still observed, and lighting performance of a uniform planar light source still cannot be achieved.

In another type of the existing traffic light, light emitting elements with a high power are mainly adopted in collaboration with a transparent front cover, a Fresnel lens and a secondary lens to modify a light shape to achieve the effect of the uniform planar light source. However, such manner results in a fact that too many optical elements are used, which leads to problems of low light emitting efficiency and a large volume, etc. Moreover, since such type of traffic light has the large volume, transport cost thereof is higher. Moreover, such type of traffic light cannot produce a composite image with two or more colors.

### SUMMARY OF THE INVENTION

The invention is directed to a traffic light, which is adapted to provide a planar light source, and has higher light emitting efficiency and a smaller volume.

An embodiment of the invention provides a traffic light including a plurality of light emitting elements and at least one light guide plate. Each of the light emitting elements is configured to emit a light. The light emitting elements are disposed beside a light entering surface of the at least one light guide plate. Each of the lights enters the at least one light guide plate through the light entering surface of the at least one light guide plate.

In an embodiment of the invention, the number of the at least one light guide plate is plural. The light guide plates include a first light guide plate and a plurality of second light guide plates. The second light guide plates are disposed in the first light guide plate. The light entering surface of the first light guide plate is a first light entering surface, the light entering surfaces of the second light guide plates are a plurality of second light entering surfaces. The light emitting elements include a plurality of first light emitting elements and a plurality of second light emitting elements. The light emitted by each of the first light emitting elements is a first light. The light emitted by each of the second light emitting elements is a second light. The first light emitting elements are disposed beside the first light entering surface of the first light guide plate, and the first lights are emitted out through the first light guide plate. At least one of the second light emitting elements is disposed beside the second light entering surface of each of the second light guide plates, and each of the second light is emitted out through the corresponding second light guide plate.

In an embodiment of the invention, the traffic light further includes a circuit carrier, which is electrically coupled to the first light emitting elements and the second light emitting elements, and configured to adjust brightness of the first emitting elements and the second light emitting elements.

In an embodiment of the invention, the circuit carrier controls the first light emitting elements to emit lights, and controls at least a part of the second light emitting elements to emit lights or controls the second light emitting elements not to emit light.

In an embodiment of the invention, the circuit carrier controls the first light emitting elements not to emit light, and controls at least a part of the second light emitting elements to emit lights.

In an embodiment of the invention, the first light guide plate has a plurality of hollow portions, and the second light guide plates are respectively disposed in the hollow portions.

In an embodiment of the invention, the traffic light further includes a plurality of light block portions, the light block portions are correspondingly disposed at the hollow portions, and each of the light block portions is located between the first light guide plate and the corresponding second light guide plate.

In an embodiment of the invention, a height of each of the light block portions is greater than a thickness of the first light guide plate and a thickness of the corresponding second light guide plate.

In an embodiment of the invention, the first light entering surface is a side surface of the first light guide plate, and the second light entering surfaces are a plurality of side surfaces of the second light guide plates.

In an embodiment of the invention, the first light entering surface is a bottom surface of the first light guide plate, and the second light entering surfaces are respectively a plurality of bottom surfaces of the second light guide plates.

In an embodiment of the invention, the traffic light further includes a transparent cover, and the light emitting element and the at least one light guide plate are disposed in the transparent cover.

In an embodiment of the invention, the transparent cover is a dyed cover.

In an embodiment of the invention, the traffic light further includes a filter element. The filter element is disposed at a light path downstream of the at least one light guide plate.

Based on the above description, in the traffic light of the invention, through configuration of the light guide plate, the lights of the light emitting element are transformed into a planar light source, and meanwhile higher light emitting efficiency and a smaller volume of the traffic light are achieved, which results in lower transport cost.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a front view of a traffic light according to an embodiment of the invention.

FIG. 1B is a cross-sectional view of the embodiment of FIG. 1A at a section line A-A′.

FIG. 2 is a cross-sectional view of a traffic light according to another embodiment of the invention.

FIG. 3 is a cross-sectional view of a traffic light according to still another embodiment of the invention.

FIG. 4A is a front view of a traffic light according to another embodiment of the invention.

FIG. 4B is a cross-sectional view of the embodiment of FIG. 4A at a section line B-B′.

FIG. 4C is a front view of a first LGP in FIG. 4A and FIG. 4B.

FIG. 4D is a front view of a second LGP in FIG. 4A and FIG. 4B.

FIG. 4E is a light emitting schematic diagram of the traffic light of FIG. 4A and FIG. 4B under a first condition.

FIG. 4F is a light emitting schematic diagram of the traffic light of FIG. 4A and FIG. 4B under a second condition.

FIG. 4G is a light emitting schematic diagram of the traffic light of FIG. 4A and FIG. 4B under a third condition.

FIG. 4H is a light emitting schematic diagram of the traffic light of FIG. 4A and FIG. 4B under a fourth condition.

FIG. 5A is a front view of a traffic light according to another embodiment of the invention.

FIG. 5B is a cross-sectional view of the embodiment of FIG. 5A at a section line C-C′.

FIG. 5C is a cross-sectional view of the embodiment of FIG. 5A at a section line D-D′.

FIG. 6A is a front view of a traffic light according to another embodiment of the invention.

FIG. 6B is a cross-sectional view of the embodiment of FIG. 6A at a section line E-E′.

FIG. 7A is a front view of a traffic light according to another embodiment of the invention.

FIG. 7B is a cross-sectional view of the embodiment of FIG. 7A at a section line F-F′.

FIG. 7C is a cross-sectional view of the embodiment of FIG. 7A at a section line G-G′.

FIG. 8A is a front view of a traffic light according to another embodiment of the invention.

FIG. 8B is a cross-sectional view of the embodiment of FIG. 8A at a section line H-H′.

### DESCRIPTION OF EMBODIMENTS

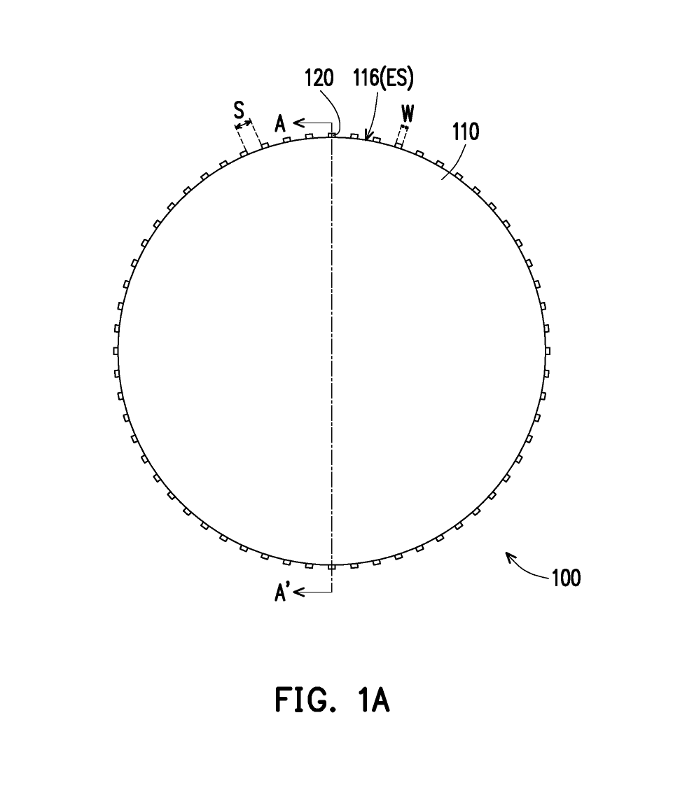

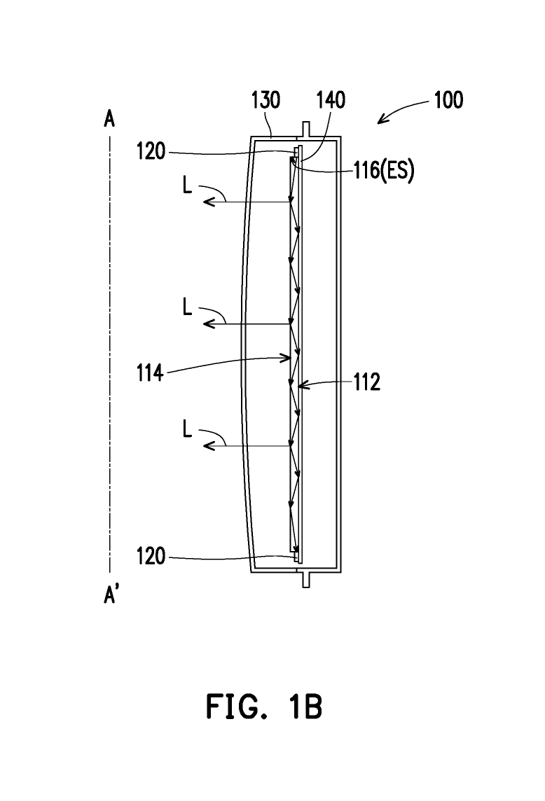

FIG. 1A is a front view of a traffic light according to an embodiment of the invention. FIG. 1B is a cross-sectional view of the embodiment of FIG. 1A at a section line A-A′. It should be noted that for simplicity's sake, a transparent cover and a circuit carrier are omitted in FIG. 1A.

Referring to FIG. 1A and FIG. 1B, in the present embodiment, the traffic light 100 includes at least one light guide plate (LGP) 110, a plurality of light emitting elements 120, a transparent cover 130 and a circuit carrier 140. The above components are described in detail below.

The LGP 110 is an optical element adapted to guide a propagation direction of lights in the traffic light 100. The LGP 110 has a bottom surface 112, a top surface 114 and a side surface 116. The bottom surface 112 is opposite to the top surface 114. The side surface 116 is connected to the bottom surface 112 and the top surface 114.

In the present embodiment, a material of the LGP 110 may be Polycarbonate (PC), Polymethylmethacrylate (PMMA), glass or a group consisting of the above materials, which is not limited by the invention. In the present embodiment, the number of the at least one LGP 110 is one. Referring to FIG. 1A, a shape of the LGP 110 is, for example, a round shape, though the invention is not limited thereto. Referring to FIG. 1B, the LGP 110 is, for example, a flat LGP, though the invention is not limited thereto.

The light emitting elements 120 generally refer to optical elements with a light emitting function, and each of the light emitting elements 120 is used for emitting a light L. The light emitting element 120 may be an optical element with the light emitting function such as a Light Emitting Diode (LED), an Organic Light Emitting Diode (OLED), a Polymer Light Emitting Diode (PLED), etc., though the invention is not limited thereto. In the present embodiment, the light emitting element 120 is an LED, and is, for example, a Surface Mounted Device LED (SMD LED), and is, for example, an LED adapted to emit a white light. In other embodiments, a color of the light emitted by the light emitting element 120 may be a red color, a green color, a blue color or other color, which is not limited by the invention. The LED may have a size of 5×5 mm, 3×2 mm or may be a micro LED of a micron level, which is not limited by the invention. In the present embodiment, a size W of each of the light emitting elements 120 is, for example, the same. However, in other embodiments, each of the light emitting elements 120 may respectively have a different size W, or a part of the light emitting elements 120 have the same size, and another part of the light emitting elements 120 have other different size W, and those with ordinary skills in the art may design the size W of the light emitting elements 120 according to an actual requirement, which is not limited by the invention.

The transparent cover 130 generally refers to a cover that is pervious to light and has a protection function. The at least one LGP 110, the light emitting elements 120 and the circuit carrier 140 are disposed in the transparent cover 130. The transparent cover 130 provides a protection function to the aforementioned components, so as to prevent the above components from being impacted or contaminated by dust to avoid affecting a whole electrical characteristic of the traffic light 100.

The circuit carrier 140 is electrically coupled to the light emitting elements 120, and adjusts a brightness of the light emitting elements 120. In detail, a method that the circuit carrier 140 adjusts the brightness of the light emitting elements 120 may include turning on/off the light emitting elements 120, alternatively, when the light emitting elements 120 are in a turn-on state, the light emitting brightness of the light emitting elements 120 is adjusted, which is not limited by the invention. The light emitting elements 120 are disposed on the circuit carrier 140. The circuit carrier 140 is, for example, a rigid circuit board, a flexible circuit board or a circuit carrier formed by disposing a flexible circuit thin-film on a rigid board, which is not limited by the invention.

Configuration relationships of the aforementioned various components and optical behaviours in the traffic light 100 are described in detail below.

In the present embodiment, the light emitting elements 120 are disposed beside a light entering surface ES of the LGP 110. A side surface 116 of the LGP 110 serves as the light entering surface ES. Namely, a configuration manner of the light emitting elements 120 and the LGP 110 is, for example, a side-type configuration. A space S between every two of the light emitting elements 120 is, for example, the same. In other embodiments, the space S between every two of the light emitting elements 120 may also be different, which is not limited by the invention. The transparent cover 130 is disposed at a light path downstream of the LGP 110. In the embodiment of the invention, the situation that a second element is disposed at a light path downstream of a first element refers to that the light L first passes through the first element and then passes through the second element. Therefore, according to the above description, when the circuit carrier 140 controls the light emitting elements 120 to emit the light L, the light L enters the LGP 110 through the side surface 116 of the LGP 110, and implements one or multiple total internal reflections between the top surface 114 and the bottom surface 112, and is emitted out of the LGP 110 through the top surface 114. The light L again penetrates through the transparent cover 130 for emitting out of the traffic light 100, such that a user may view an image displayed by the traffic light 100.

In other embodiments, a plurality of V-shape structures (not shown) may be formed on the top surface 114 of the LGP 110, which are used for controlling a light emitting direction of the light L, though the invention is not limited thereto.

According to the above description, in the traffic light 100 of the present embodiment, through configuration of the LGP 110, a lighting performance of the light L emitted by the light emitting elements 120 is transformed into a form of a planar light source. Moreover, since a thickness of the LGP 110 used in the traffic light 100 of the present embodiment is generally thinner than a thickness of a combination of lenses and a front cover (a transparent front cover, a Fresnel lens and a secondary lens) adopted by the existing technique, and less optical elements are used compared with that of the existing technique, the traffic light 100 of the present embodiment may have higher light emitting efficiency and a smaller volume under the lighting performance of the planar light source. Further, since the traffic light 100 of the present embodiment has the smaller volume, a lower transport cost is achieved.

It should be noted that reference numbers of the components and a part of contents of the aforementioned embodiment are also used in the following embodiment, where the same reference numbers denote the same or like components, and descriptions of the same technical contents are omitted. The aforementioned embodiment can be referred for descriptions of the omitted parts, and detailed descriptions thereof are not repeated in the following embodiment.

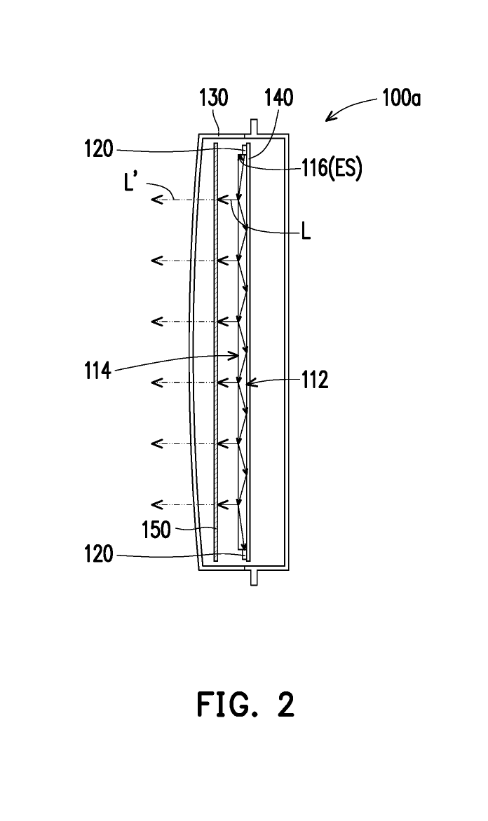

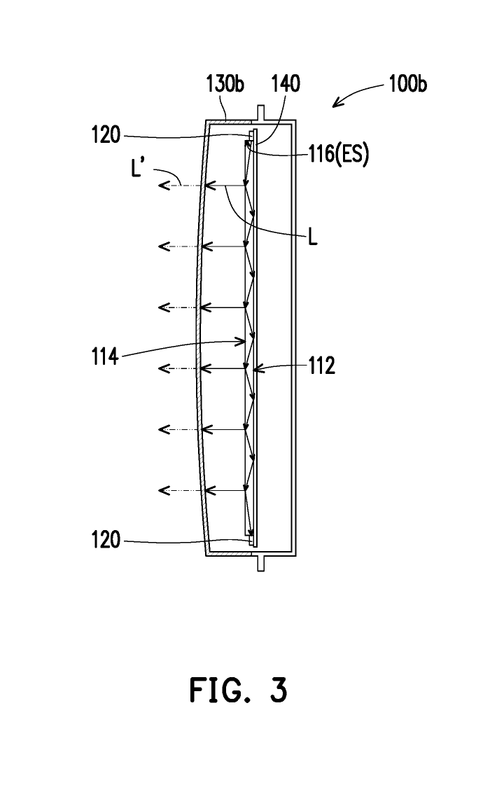

FIG. 2 is a cross-sectional view of a traffic light according to another embodiment of the invention. FIG. 3 is a cross-sectional view of a traffic light according to still another embodiment of the invention.

Referring to FIG. 2, the traffic light 100a of the present embodiment is substantially similar to the traffic light 100, and a main difference there between is that the traffic light 100a further includes a filter element 150. The filter element 150 of the embodiment of the invention is, for example, an optical element adapted to filter lights of a specific waveband and pervious to lights of other wavebands. The filter element 150 is disposed in the transparent cover 130, and is disposed at the light path downstream of the at least one LGP 110. Therefore, after the light L emitted by the light emitting elements 120 is emitted out from the LGP 110, the light L is propagated to the filter element 150. The filter element 150 filters lights of a specific waveband in the light L and is pervious to lights of other waveband in the light L. For example, the filter element 150 may filter a blue light and a green light, and is pervious to a red light, though the invention is not limited thereto. Therefore, after the light L (for example, a white light) penetrates through the filter element 140, a light L′ with the red waveband in the light L may sequentially penetrate through the filter element 150 and the transparent cover 130 and is emitted out of the traffic light 100a. In other embodiments, wavelength selectivity of the filter element 150 may be adjusted according to user's requirement, which is not limited by the invention.

Referring to FIG. 3, the traffic light 100b of the present embodiment is substantially similar to the traffic light 100, and a main difference there between is that the transparent cover 130b of the traffic light 100b is a dyed cover. In the present embodiment, the transparent cover 130b is, for example, dyed into a red color, so that when the light L penetrates through the transparent cover 130b, the light L′ with the red waveband in the light L may be emitted out from the traffic light 100b. In other embodiments, wavelength selectivity of the transparent cover 130b may be adjusted according to user's requirement, which is not limited by the invention.

According to the above description, in the traffic lights 100a, 100b of the aforementioned embodiments, by configuring the filter element 150 or selecting the dyed cover to serve as the transparent cover 130b, the color of light emitted out of the traffic lights 100a, 100b may be simply changed, so as to meet various demands, and improve commonality of the LGP 110 and the light emitting elements 120.

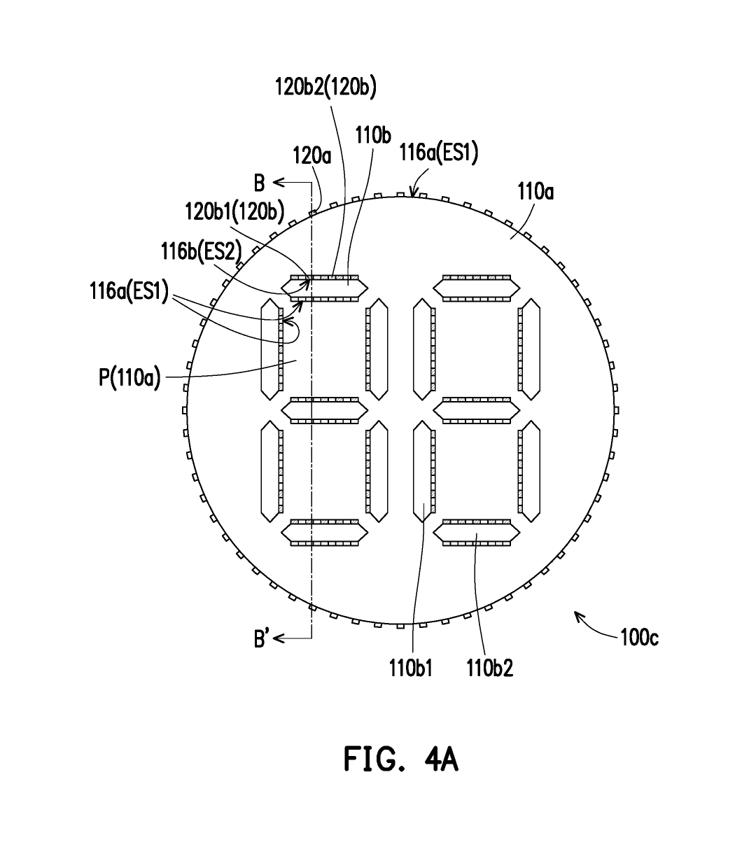

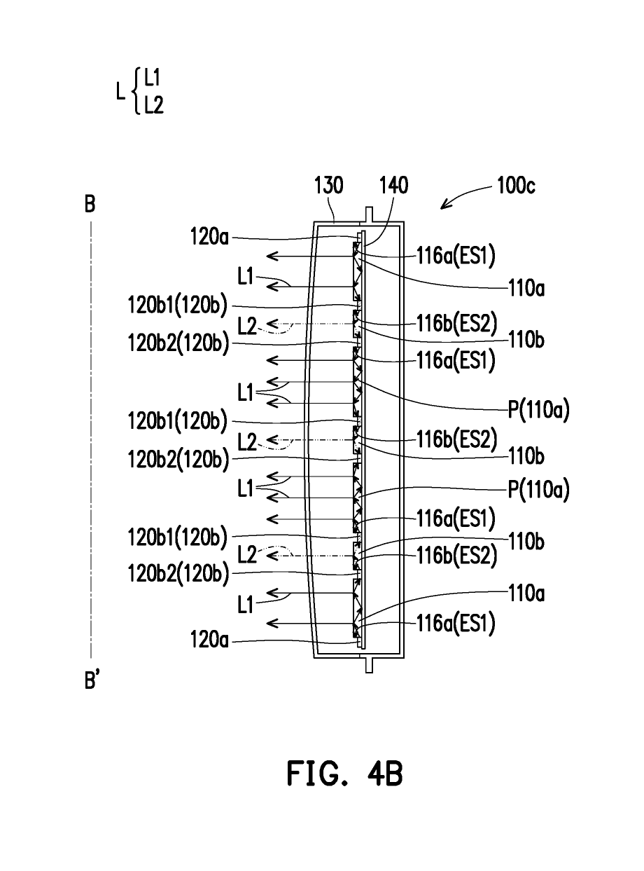

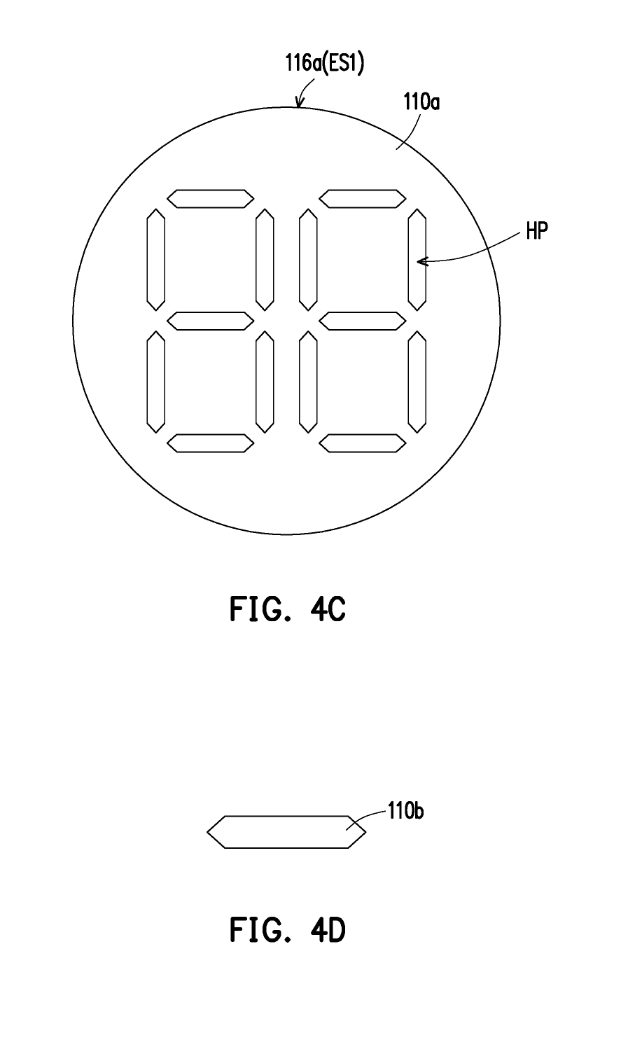

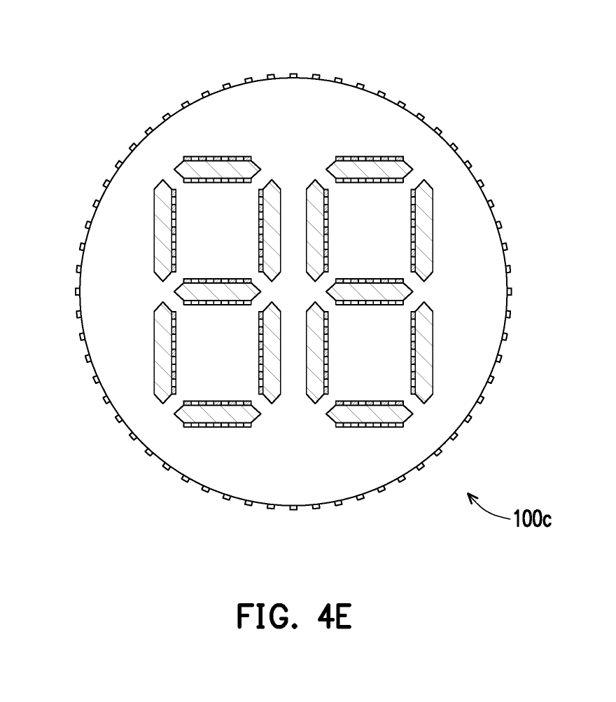

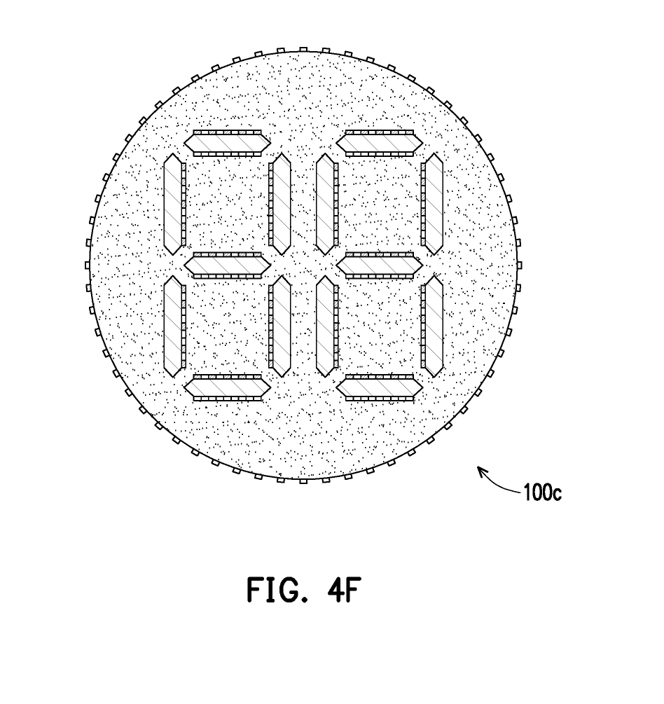

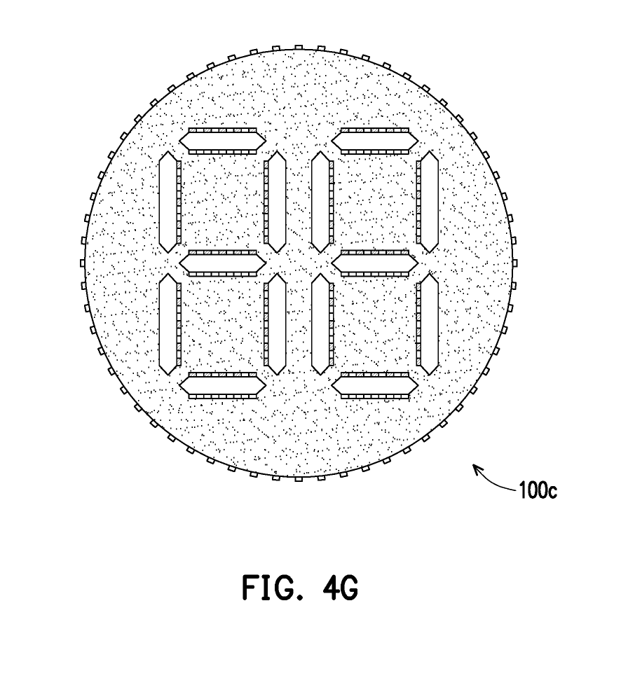

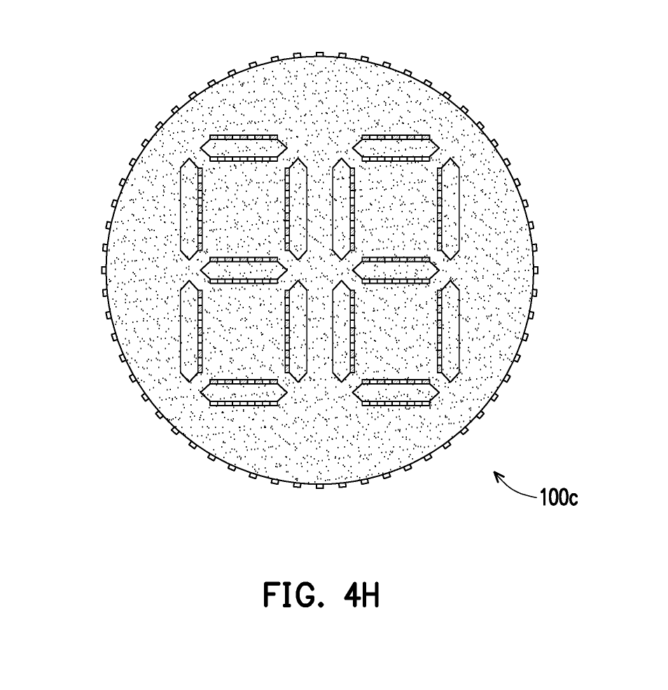

FIG. 4A is a front view of a traffic light according to another embodiment of the invention. FIG. 4B is a cross-sectional view of the embodiment of FIG. 4A at a section line B-B′. FIG. 4C is a front view of a first LGP in FIG. 4A and FIG. 4B.

FIG. 4D is a front view of a second LGP in FIG. 4A and FIG. 4B. FIG. 4E is a light emitting schematic diagram of the traffic light of FIG. 4A and FIG. 4B under a first condition. FIG. 4F is a light emitting schematic diagram of the traffic light of FIG. 4A and FIG. 4B under a second condition. FIG. 4G is a light emitting schematic diagram of the traffic light of FIG. 4A and FIG. 4B under a third condition. FIG. 4H is a light emitting schematic diagram of the traffic light of FIG. 4A and FIG. 4B under a fourth condition. It should be noted that for clarity's sake, the transparent cover and the circuit carrier are omitted in FIG. 4A.

Referring to FIG. 4A to FIG. 4D, the traffic light 100c of the present embodiment is substantially similar to the traffic light 100, and a main difference there between is that in the traffic light 100c, the number of the first LGP 110 is plural. The LGPs 110 include a first LGP 110a and a plurality of second LGPs 110b. The second LGPs 110b are disposed in the first LGP 110a. In detail, an outer profile of the first LGP 110a is a round, and the first LGP 110a has a plurality of hollow portions HP (referring to FIG. 4C). Shapes of the second LGPs 110b are complementary to the shapes of the hollow portions HP (referring to FIG. 4C and FIG. 4D). The second LGPs 110b are respectively disposed in the hollow portions HP. The hollow portions HP form a hollow pattern. The hollow pattern is, for example, a pattern of “88”, and those skilled in the art may design the shape of the hollow pattern according to an actual requirement, which is not limited by the invention. A first light entering surface ES1 is the side surface 116a of the first LGP 110a. A plurality of second light entering surfaces ES2 are respectively a plurality of side surfaces 116b of the second LGPs 110b. The light emitting elements 120 include a plurality of first light emitting elements 120a and a plurality of second light emitting elements 120b. The light L emitted by each of the first light emitting elements 120a is a first light L1. The light L emitted by each of the second light emitting elements 120b is a second light L2. In the present embodiment, a color of the first light L1 is a yellow color, a color of the second light L2 includes two colors, and the two colors are, for example, the yellow color and the red color. In other words, the first light emitting elements 120a are yellow light emitting elements 120a 120b2, and the second light emitting elements 120b include light emitting elements with different lighting colors. For example, the second light emitting elements 120b include a plurality of red light emitting elements 120b1 and a plurality of yellow light emitting elements 120b2. In other embodiments, the color of the first light L1 may also be green, and the color of the second light L2 may also be blue, green or a combination of blue and green, or other color combinations, which is not limited by the invention. The first light emitting elements 120a are disposed beside the first light entering surface ES1 of the first LGP 110a. A portion P of the first LGP 110a is surrounded by a plurality of the second LGPs 110b, and the second light emitting elements 120b are disposed beside the first light entering surface ES1 corresponding to the portion P. The first lights L1 are emitted out through the first LGP 110a. At least one second light emitting element 120b is disposed beside the second light entering surface 116b of each of the second LGPs 110b. Each of the second lights L2 is emitted out through the corresponding second LGP 110b.

According to the above description, in the present embodiment, the circuit carrier 140 adjusts brightness of the first light emitting elements 120a and the second light emitting elements 120b. Display effects of the traffic light 100c of the embodiment under different situations are described in detail below.

Referring to FIG. 4E, in a first situation, the circuit carrier 140 controls the first light emitting elements 120a not to emit light, and controls at least a part of the second light emitting elements 120b to emit lights (for simplicity's sake, a situation that all of red light emitting elements 120b1 are controlled to emit lights and all of the yellow light emitting elements 120b2 are controlled not to emit light is taken as an example for description, though the invention is not limited thereto). Therefore, in the first situation, the second lights L2 may be emitted out through all of the second LGPs 110b to display an image of “88” in the second color (for example, the red color (an oblique line part)).

Referring to FIG. 4F, in a second situation, the circuit carrier 140 controls the first light emitting elements 120a to emit lights, and controls at least a part of the second light emitting elements 120b to emit lights. To be specific, the circuit carrier 140, for example, controls the red light emitting elements 120b1 in the second light emitting elements 120b to emit lights. Therefore, in the second situation, the first lights L1 are emitted out through the first LGP 110a, and the second lights L2 are emitted out through the corresponding second LGPs 110b, so as to display an image with a background in the first color (for example, the yellow color (a dot part)) and a character pattern of “88” in the second color (for example, the red color (an oblique line part)).

Referring to FIG. 4G, in a third situation, the circuit carrier 140 controls the first light emitting elements 120a to emit lights, and controls the second light emitting elements 120b not to emit light, so as to display an image with a background in the first color (for example, the yellow color (a dot part)) and a character pattern of “88” in none color.

Referring to FIG. 4H, in a fourth situation, the circuit carrier 140 controls the first light emitting elements 120a to emit lights, and controls all of the yellow light emitting elements 120b2 in the second light emitting elements 120b to emit lights and controls all of the red light emitting elements 120b1 in the second light emitting elements 120b not to emit light. Therefore, in the fourth situation, the first lights L1 are emitted out through the first LGP 110a, and the second lights L2 are emitted out through the corresponding second LGPs 110b, so as to display a round image with the yellow color (i.e. the yellow light).

In the aforementioned first, second and fourth situations, the circuit carrier 140, for example, controls all of the red light emitting elements 120b1 in the second light emitting elements 120b or all of the yellow light emitting elements 120b2 in the second light emitting elements 120b to emit lights. Certainly, the circuit carrier 140 may also control a part of the red light emitting elements 120b1 or a part of the yellow light emitting elements 120b2 to emit lights. For example, the circuit carrier 140 may control a part of the second light emitting elements 120b corresponding to two second LGPs 110b1, 110b2 located a lower left part of the character “8” located to the right side of the image not to emit light and control the red light emitting elements corresponding to other second LGPs 110b to emit lights, so as to display an image with a character pattern of “87” in the second color (the red color). Similarly, the circuit carrier 140 may control the red light emitting elements 120b1 of different positions to/not to emit light at different timings, so as to display images of different character patterns (for example, “99”, “98”, “97”, . . . , “01”), such that the traffic light 100c, for example, has a countdown function, though the invention is not limited thereto.

According to the above description, in the traffic light 100c of the present embodiment, by configuring the first light emitting elements 120a and the second light emitting elements 120b and using the circuit carrier 140 to adjust the brightness of the first light emitting elements 120a and the second light emitting elements 120b, the traffic light 100c may display an image of a single color or an image with a composite color. Further, the circuit carrier 140 may control the brightness of the first light emitting elements 120a and the second light emitting elements 120b in timing, so that the traffic light 100c may have the countdown function.

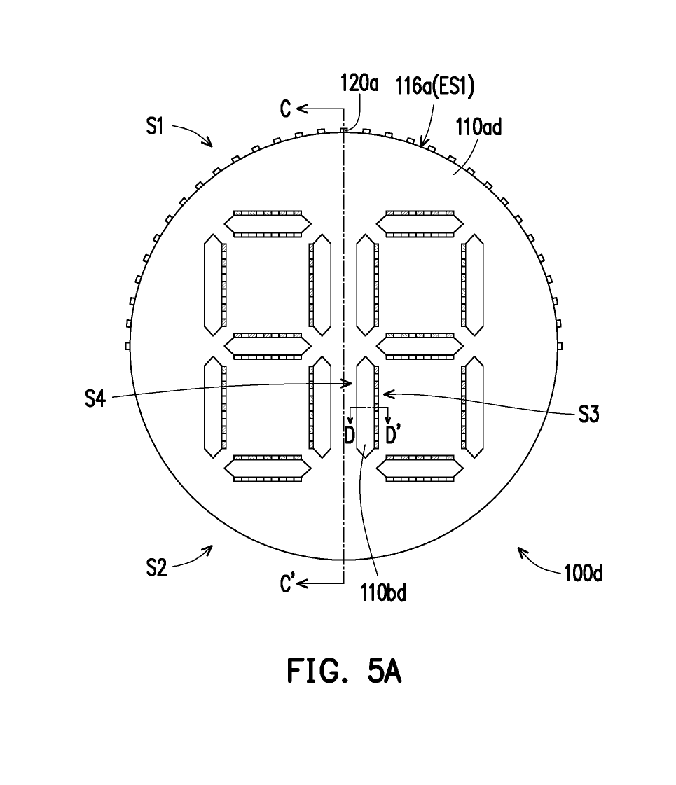

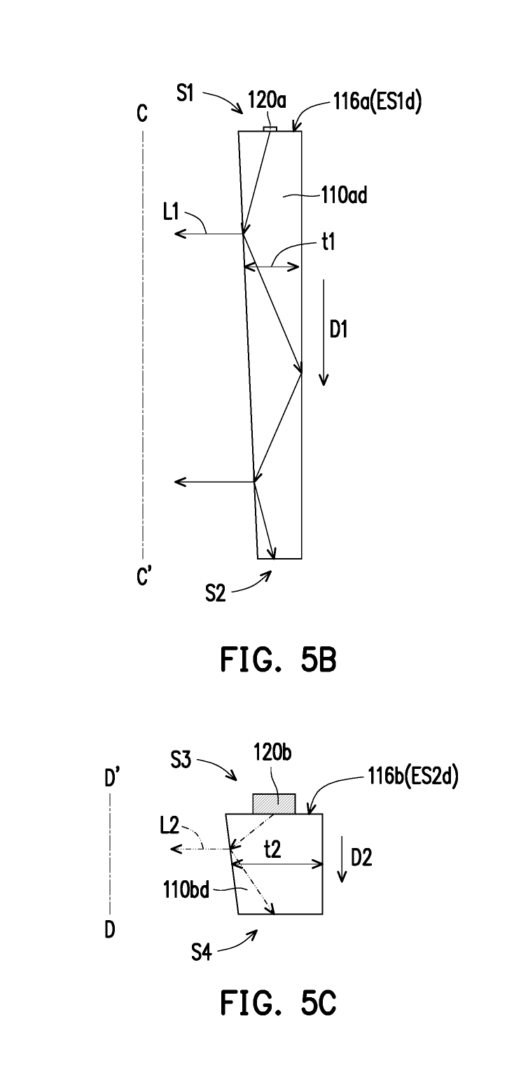

FIG. 5A is a front view of a traffic light according to another embodiment of the invention. FIG. 5B is a cross-sectional view of the embodiment of FIG. 5A at a section line C-C′. FIG. 5C is a cross-sectional view of the embodiment of FIG. 5A at a section line D-D′. It should be noted that for simplicity's sake, the transparent cover and the circuit carrier are omitted in FIG. 5A.

Referring to FIG. 5A and FIG. 5B, the traffic light 100d of the present embodiment is substantially similar to the traffic light 100c of FIG. 4A and FIG. 4B, and a main difference there between is that in the traffic light 100d, the first LGP 100ad has a first side Si and a second side S2 opposite to each other. The first light emitting elements 120a are disposed at the first side S1 of the first LGP 110ad, and the second side S2 of the first LGP 110ad is not configured with any first light emitting element 120a. Referring to FIG. 5B, a thickness t1 of the first LGP 110ad is decreased progressively along a direction D1 from the first side S1 to the second side S2. In other words, the first LGP 110ad is, for example, a wedge type LGP, and the first light emitting elements 120a are disposed beside the first light entering surface ES1d corresponding to a thicker portion of the first LGP 110ad.

Referring to FIG. 5C, in the present embodiment, in the present embodiment, the second LGP 110bd has a third side S3 and a fourth side S4 opposite to each other.

The third side S3 of the second LGP 110bd is configured with at least one second light emitting element 120b, and a thickness t2 of each of the second LGPs 110bd is decreased progressively along a direction D2 from the third side S3 to the fourth side S4. In other words, the second LGP 110bd is, for example, a wedge type LGP. The at least one second light emitting element 120b is disposed beside the second light entering surface ES2d corresponding to a thicker portion of the second LGP 110bd, and the other side S4 of the second LGP 110bd is not configured with any second light emitting element 120b.

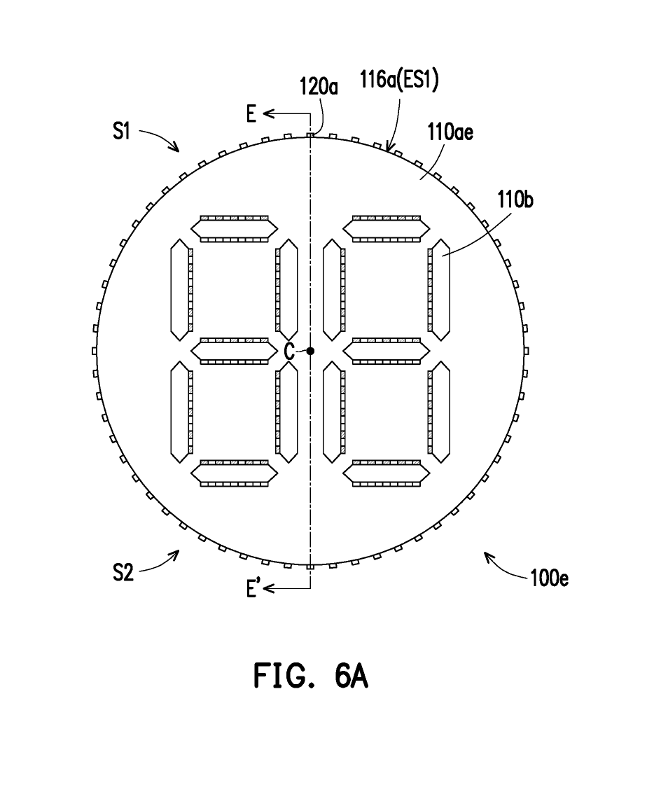

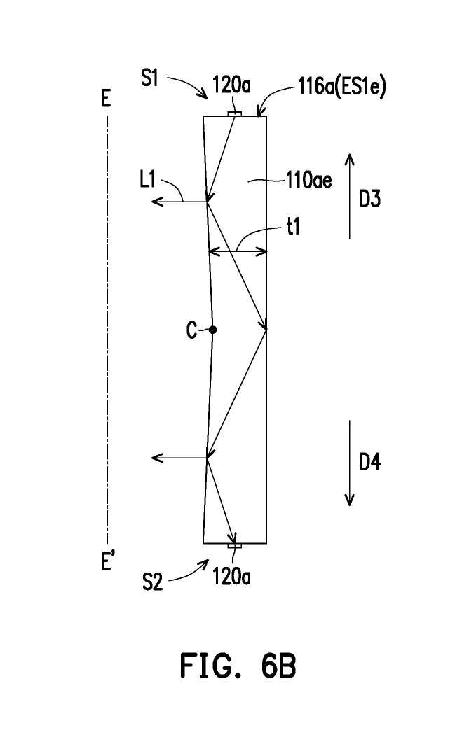

FIG. 6A is a front view of a traffic light according to another embodiment of the invention. FIG. 6B is a cross-sectional view of the embodiment of FIG. 6A at a section line E-E′. It should be noted that for simplicity's sake, the transparent cover and the circuit carrier are omitted in FIG. 6A.

Referring to FIG. 6A and FIG. 6B, the traffic light 100e of the present embodiment is substantially similar to the traffic light 100d of FIG. 5A and FIG. 5B, and a main difference there between is that in the traffic light 100e, the first light emitting elements 120a are disposed at the first side S1 and the second side S2 of the first LGP 110ae. The thickness t1 of the first LGP 110ae is increased progressively along direction D3, D4 from a center C to the first side S1 and the second side S2.

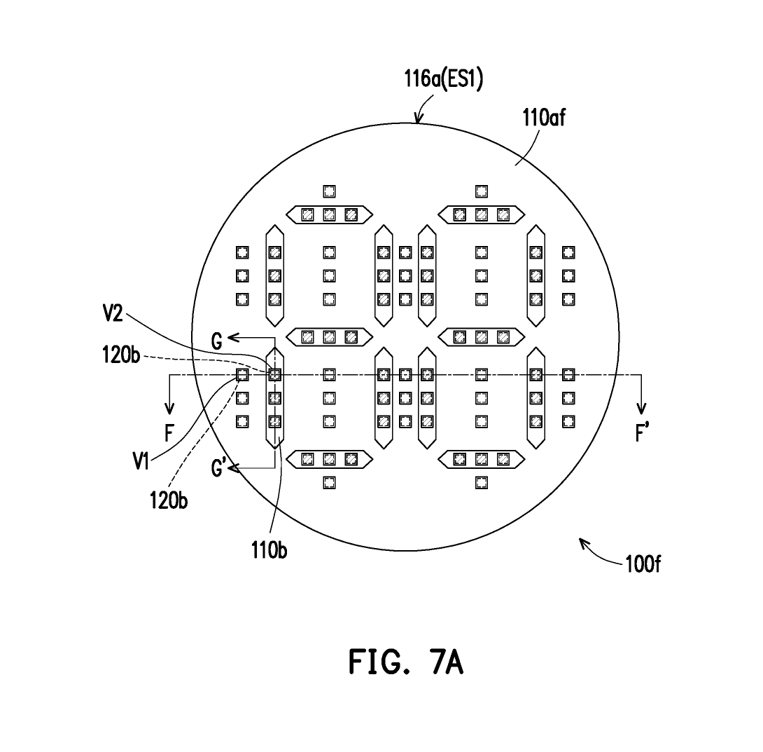

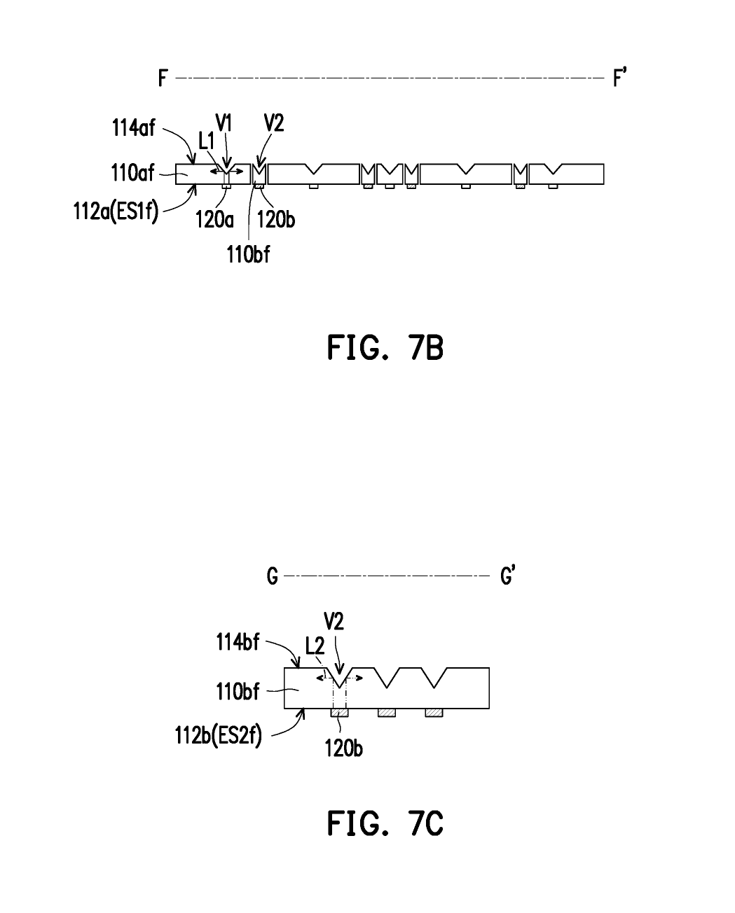

FIG. 7A is a front view of a traffic light according to another embodiment of the invention. FIG. 7B is a cross-sectional view of the embodiment of FIG. 7A at a section line F-F′. FIG. 7C is a cross-sectional view of the embodiment of FIG. 7A at a section line G-G′. It should be noted that for simplicity's sake, the transparent cover and the circuit carrier are omitted in FIG. 7A.

Referring to FIG. 7A to FIG. 7C, the traffic light 100f of the present embodiment is substantially similar to the traffic light 100c of FIG. 4A and FIG. 4B, and a main difference there between is that in the traffic light 100f, the first light entering surface ES1f is a bottom surface 112a of the first LGP 110af (referring to FIG. 7B). Namely, the first light L1 enters the first LGP 110af from the bottom surface 112a of the first LGP 110af. A configuration method of the first light emitting elements 120a and the first LGP 110a is, for example, a direct-under type configuration method. The second light entering surfaces ES2f are respectively a plurality of bottom surfaces 112b of the second LGPs 110bf. Namely, the second lights L2 enter the second LGPs 110bf from the bottom surfaces 112b of the second LGPs 110bf (referring to FIG. 7C). A configuration method of the second light emitting elements 120b and the second LGPs 110b is, for example, a direct-under type configuration method. To be specific, the first LGP 110a further includes a plurality of first optical microstructures Vl. The first optical microstructures V1 are formed on the top surface 114af of the first LGP 110af, and positions of the first optical microstructures V1 respectively correspond to positions of the first light emitting elements 120a. Each of the second LGPs 110b further includes a plurality of second optical microstructures V2. The second optical microstructures V2 are formed on the top surface 114bf of each of the second LGPs 110bf. Positions of the second optical microstructures V2 respectively correspond to positions of the second light emitting elements 120b. In the present embodiment, the first optical microstructures V1 and the second optical microstructures V2 are all V-shape structures, though the invention is not limited thereto. The first optical microstructures V1 and the second optical microstructures V2 are, for example, formed through a printing manner or a non-printing manner, where the non-printing manner is, for example, mechanical processing, etching or stamping, etc., which is not limited by the invention.

Through the configuration relationship between the positions of the first optical microstructures V1 and the first light emitting elements 120a, when the first light emitting element 120a emits the first light L1, the first light L1 may be reflected by the corresponding first optical microstructure V1 to implement one or multiple total internal reflections within the first LGP 110af, and is then emitted out of the first LGP 110af. Similarly, through the configuration relationship between the positions of the second optical microstructures V2 and the second light emitting elements 120b, when the second light emitting element 120b emits the second light L2, the second light L2 may be reflected by the corresponding second optical microstructure V2 to implement one or multiple total internal reflections within the second LGP 110bf, and is then emitted out of the second LGP 110bf. In brief, through the aforementioned configuration, the uniformity of the planar light source is better.

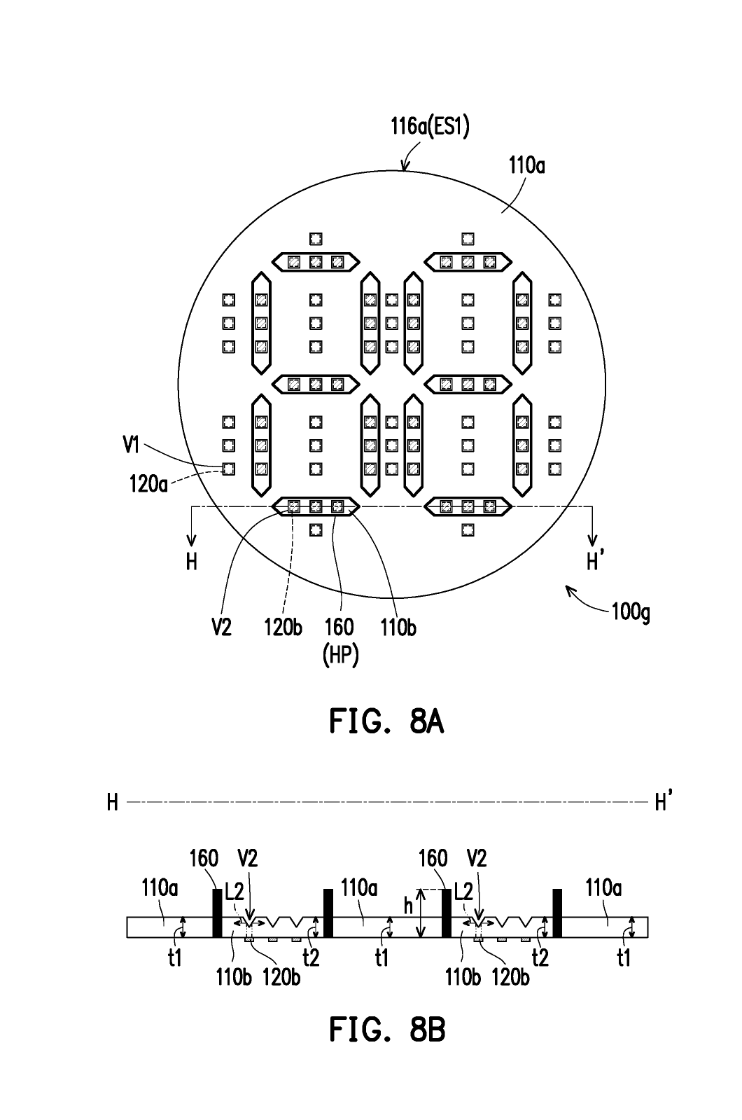

FIG. 8A is a front view of a traffic light according to another embodiment of the invention. FIG. 8B is a cross-sectional view of the embodiment of FIG. 8A at a section line H-H′. It should be noted that for simplicity's sake, the transparent cover and the circuit carrier are omitted in FIG. 8A.

Referring to FIG. 8A to FIG. 8B, the traffic light 100g of the present embodiment is substantially similar to the traffic light 100c of FIG. 4A and FIG. 4B, and a main difference there between is that the traffic light 100g further includes a plurality of light block portions 160. In the present embodiment of the invention, the light block portions 160 generally refer to optical elements adapted to block light. The light block portions 160 are, for example, baffles having a reflection function, though the invention is not limited thereto. The light block portions 160 are correspondingly disposed at the hollow portions HP, respectively. To be specific, a shape of each of the light block portions 160 is complementary to a shape of the corresponding second LGP 110b. The shape of each of the light block portions 160 is complementary to a shape of the corresponding hollow portion HP. Each of the light block portions 160 is located between the first LGP 110a and the corresponding second LGP 110b. Each of the light block portions 160 surrounds the corresponding second LGP 110b. In the present embodiment, a height h of the light block portion 160 is greater than the thickness t1 of the first LGP 110a and the thickness t2 of the second LGP 110b.

Through the above configuration, when the first light emitting element 120a emits the first light L1, a part of the first light L1 emitted out from the side surface of the first LGP 110a is blocked by the light block portion 160, and is not liable to be transmitted to the adjacent second LGP 110b. On the other hand, when the second light emitting element 120b emits the second light L2, a part of the second light L2 emitted out from the side surface of the second LGP 110b is blocked by the light block portion 160, and is not liable to be transmitted to the adjacent first LGP 110a, so as to avoid influencing the light emitting effect of the traffic light 100g.

Moreover, in the above embodiments, a reflection element (not shown) may be disposed under the bottom surface of the LGP 110, and the reflection element is, for example, a reflector. Therefore, when a part of the light L is emitted out of the bottom surface 112 of the LGP 110, such part of the light may be recycled through the reflection element, so as to improve light emitting efficiency. Alternatively, one or a plurality of optical films may be disposed above the LGP 110. The optical film may include a prism sheet, an anti-prism sheet or a diffuser, which is adapted to modify a light emitting direction and a light emitting angle of the light L.

In summary, in the traffic light of the invention, through configuration of the light guide plate, the lights of the light emitting element are transformed into a planar light source, and meanwhile higher light emitting efficiency and a smaller volume of the traffic light are achieved, which results in lower transport cost. Moreover, the traffic light of the invention may simply adopt a filter element or dyed cover to change the color of the light emitting elements. Moreover, in the traffic light of the invention, by configuring the first light emitting elements, the second light emitting elements of different light emitting colors and the first LGP and the second LGPs respectively corresponding to the first light emitting elements and the second light emitting elements, the traffic light may display images of composite color.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A traffic light, comprising:
a plurality of light emitting elements, each of the light emitting elements being configured to emit a light; and
at least one light guide plate, the light emitting elements being disposed beside a light entering surface of the at least one light guide plate, and each of the lights enters the at least one light guide plate through the light entering surface of the at least one light guide plate.

2. The traffic light as claimed in claim 1, wherein the number of the at least one light guide plate is plural, the light guide plates comprise a first light guide plate and a plurality of second light guide plates, the second light guide plates are disposed in the first light guide plate,
the light entering surface of the first light guide plate is a first light entering surface, the light entering surfaces of the second light guide plates are a plurality of second light entering surfaces,
the light emitting elements comprise a plurality of first light emitting elements and a plurality of second light emitting elements, the light emitted by each of the first light emitting elements is a first light, and the light emitted by each of the second light emitting elements is a second light,
the first light emitting elements are disposed beside the first light entering surface of the first light guide plate, and the first lights are emitted out through the first light guide plate,
at least one of the second light emitting elements is disposed beside the second light entering surface of each of the second light guide plates, and each of the second light is emitted out through the corresponding second light guide plate.

3. The traffic light as claimed in claim 2, further comprising a circuit carrier electrically coupled to the first light emitting elements and the second light emitting elements, and configured to adjust brightness of the first emitting elements and the second light emitting elements.

4. The traffic light as claimed in claim 3, wherein the circuit carrier controls the first light emitting elements to emit lights, and controls at least a part of the second light emitting elements to emit lights or controls the second light emitting elements not to emit light.

5. The traffic light as claimed in claim 3, wherein the circuit carrier controls the first light emitting elements not to emit light, and controls at least a part of the second light emitting elements to emit lights.

6. The traffic light as claimed in claim 2, wherein the first light guide plate has a plurality of hollow portions, and the second light guide plates are respectively disposed in the hollow portions.

7. The traffic light as claimed in claim 6, further comprising a plurality of light block portions, correspondingly disposed at the hollow portions respectively, and each of the light block portions is located between the first light guide plate and the corresponding second light guide plate.

8. The traffic light as claimed in claim 7, wherein a height of each of the light block portions is greater than a thickness of the first light guide plate and a thickness of the corresponding second light guide plate.

9. The traffic light as claimed in claim 2, wherein the first light entering surface is a side surface of the first light guide plate, and the second light entering surfaces are a plurality of side surfaces of the second light guide plates.

10. The traffic light as claimed in claim 2, wherein the first light entering surface is a bottom surface of the first light guide plate, and the second light entering surfaces are respectively a plurality of bottom surfaces of the second light guide plates.

11. The traffic light as claimed in claim 1, further comprising a transparent cover, wherein the light emitting element and the at least one light guide plate are disposed in the transparent cover.

12. The traffic light as claimed in claim 11, wherein the transparent cover is a dyed cover.

13. The traffic light as claimed in claim 1, further comprising a filter element, the filter element being disposed at a light path downstream of the at least one light guide plate.
